(19) United States
(12) Patent Application Publication
(10) Pub. No.: US 2011/0307823 A1
(43) Pub. Date: Dec. 15, 2011

(54) ELECTRONIC BOOK READER AND DISPLAYING METHOD OF ELECTRONIC BOOK READER

(75) Inventor: CHIA-CHEN WU, Tu-Cheng (TW)

(73) Assignee: HON HAI PRECISION INDUSTRY CO., LTD., Tu-Cheng (TW)

(21) Appl. No.: 12/964,231

(22) Filed: Dec. 9, 2010

(30) Foreign Application Priority Data
Jun. 15, 2010 (CN) 201010201345.5

(51) Int. Cl. G06F 3/048

(52) U.S. Cl. 715/776

(57) ABSTRACT

An electronic book includes a display, a first area displaying module, a second area displaying module, a processing module, and a browsing module. The display includes a first displaying area and a second displaying area. The first area displaying module is configured to control a list of applications to be displayed on the first displaying area. The processing module is configured to find associated information associated with an application selected by a user from the list of applications. The second area displaying module is configured to control the associated information to be displayed on the second displaying area.

### BACKGROUND

1. Technical Field

The present disclosure relates to electronic book readers, and particularly to, an electronic book reader and a displaying method of the electronic book reader.

2. Description of Related Art

An electronic book (e-book) is a text file providing the digital media equivalent of a conventional printed book. E-books are usually read on personal computers or smart phones, or on dedicated hardware devices known as e-book readers. There are only few applications, such as e-books, displayed on traditional e-book readers. Users cannot know associated information, such as descriptions of content, about theses applications.

Therefore, there is room for improvement within the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic view of an electronic book reader in accordance with an embodiment.

FIG. 2 is a block diagram of the electronic book reader of FIG. 1.

FIG. 3 is a flow chart of a displaying method of the electronic book reader of FIG. 1 in accordance with an embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

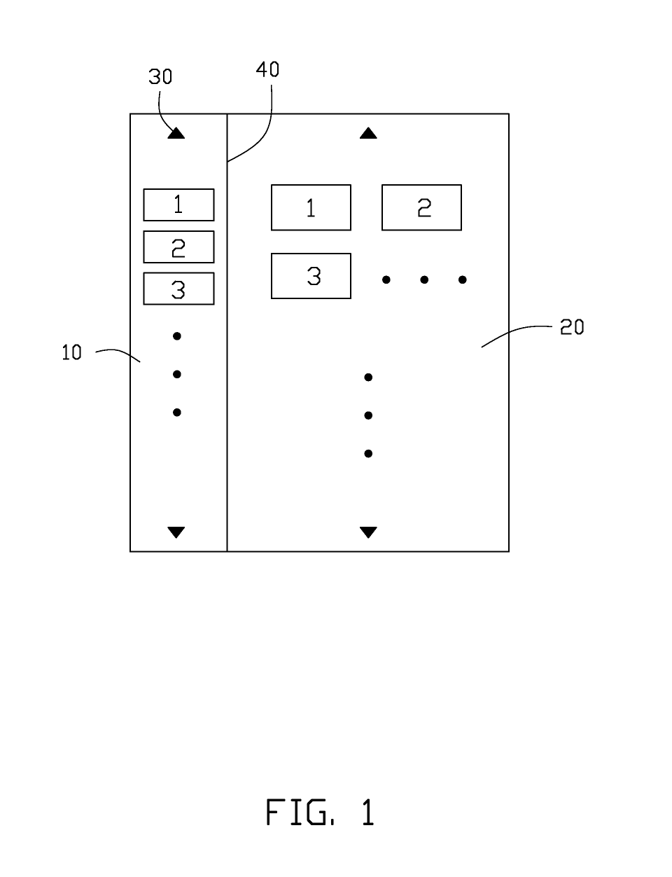

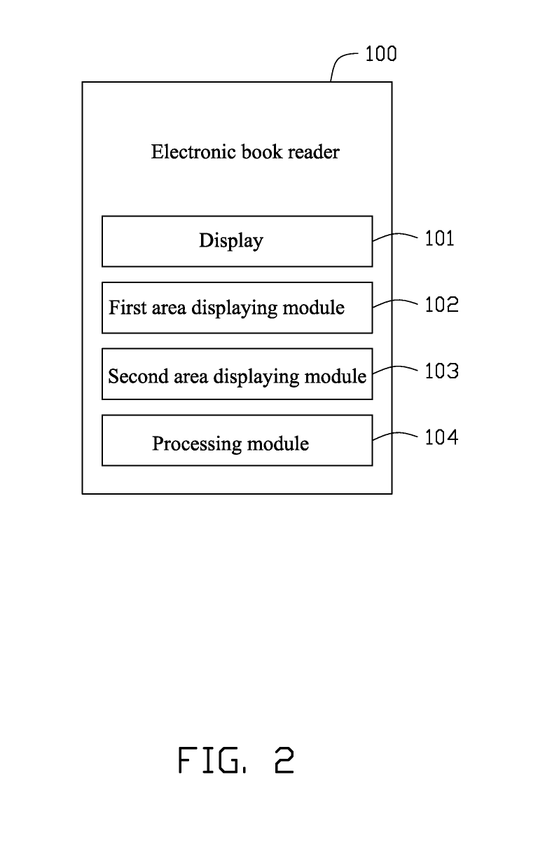

Referring to FIGS. 1 and 2, an electronic book reader 100 includes a display 101, a first area displaying module 102, a second area displaying module 103, a processing module 104, and a browsing module 105. The display 101 includes a first displaying area 10 and a second displaying area 20. The first displaying area 10 is disposed on a left side of the display 101, and the second displaying area 20 is disposed on a right side of the display 101. A separating line 40 is disposed between the first displaying area 10 and the second displaying area 20. The separating line 40 is capable of being hidden. In one embodiment, the display 101 is a touch screen.

The first area displaying module 102 is configured to control a first content to be displayed on the first displaying area 10. The first content includes a list of applications on the electronic book reader 100. In one embodiment, users are able to select an application from the list of applications.

The second area displaying module 103 is configured to control a second content to be display on the second displaying area 20. The second content includes associated information corresponding to a selected application of the list of applications.

The processing module 104 is configured to find associated information corresponding to an application selected by a user from the list of applications. The first displaying area 10 and the second displaying area 20 each include a moving terminal 30. The moving terminals 30 are configured to be pressed to scroll the list of the applications and associated information respectively.

In one embodiment, the first displaying area 10 is located above the second displaying area 20, and two moving terminals 30 of the first displaying area 10 and the second displaying area 20 are located on opposite sides of the display 101.

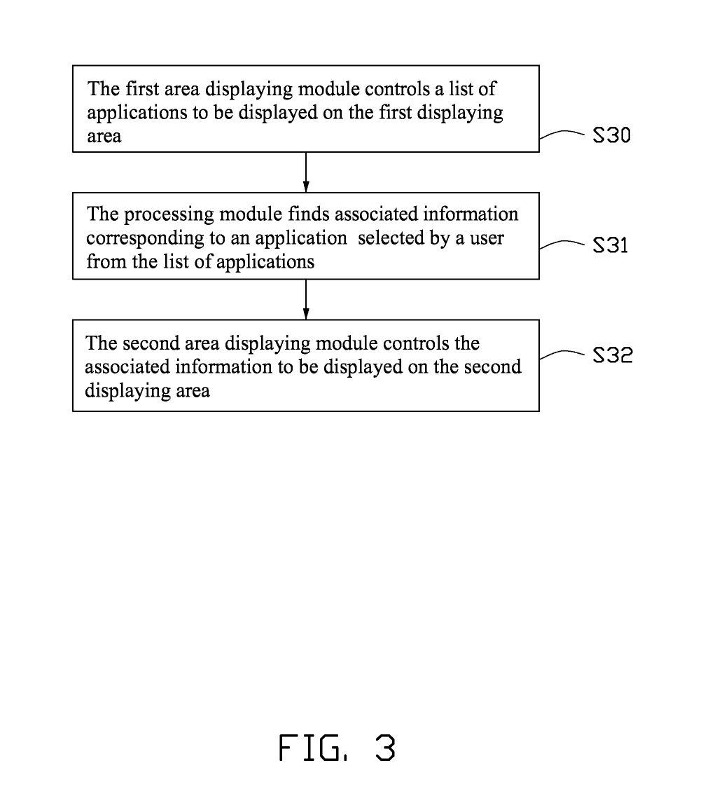

Referring to FIGS. 1 to 3, a method for displaying content on the electronic book reader is shown. An embodiment of the method is as follows.

In step S30, the first area displaying module 102 controls a list of applications to be displayed on the first displaying area 10.

In step S31, the processing module 104 finds associated information corresponding to an application selected by a user from the list of applications.

In step S32, the second area displaying module 103 controls the associated information to be displayed on the second displaying area 20.

In one embodiment, users can see a list of all applications on the display 101. Users can also see associated information corresponding the applications.

It is to be understood, however, that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the present disclosure to the full extent indicated by the broad general meaning of the terms in which the appended claims are expressed.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

What is claimed is:

1. An electronic book reader, comprising:
a display, the display comprising a first displaying area and a second displaying area;
a first area displaying module, the first area displaying module configured to control a list of applications to be displayed on the first displaying area;
a processing module, the processing module configured to find associated information associated with an application selected by a user from the list of applications; and
a second area displaying module, the second area displaying module configured to control the associated information to be displayed on the second displaying area.

2. The electronic book reader of claim 1, wherein the first displaying area and the second displaying area are disposed on opposite sides of the display.

3. The electronic book reader of claim 1, wherein a separating line is disposed between the first displaying area and the second displaying area.

4. The electronic book reader of claim 1, wherein the first displaying area and the second displaying area each comprises a moving terminal, the list of applications and the associated information are able to be scrolled via the moving terminals.

5. The electronic book reader of claim 1, wherein the display is a touch screen.

6. A displaying method of an electronic book reader, comprising:
providing a display having a first displaying area and a second displaying area;
showing a list of applications on the first displaying area;
finding associated information corresponding to a selected application; and
displaying the associated information on the second displaying area.

7. The method of claim 6, wherein the first displaying area and the second displaying area are disposed on opposite sides of the display.

8. The method of claim 6, wherein the display is a touch screen.

9. A displaying method of an electronic book reader, comprising:
providing display, the display comprising a first displaying area and a second displaying area; a first area displaying module, the first area displaying module configured to control a list of applications to be displayed on the first displaying area; a processing module, the processing module configured to find associated information associated with a selected application from the list of applications when the selected application is selected by users; and a second area displaying module, the second area displaying module configured to control the associated information to be displayed on the second displaying area;
showing the list of applications on the first displaying area;
finding associated information corresponding to a selected application; and
displaying the associated information on the second displaying area.
